(19) United States
(12) Patent Application Publication
(10) Pub. No.: US 2019/0071058 A1
(43) Pub. Date: Mar. 7, 2019

(54) OPTICAL DETECTION SYSTEM FOR MOTOR VEHICLE

(71) Applicant: Valeo Systèmes d'Essuyage, Le Mesnil Saint Denis (FR)

(72) Inventors: Giuseppe Grasso, Issoire (FR); Grégory Kolanowski, Issoire (FR); Marcel Trebouet, Le Mesnil Saint Denis (FR)

(73) Assignee: Valeo Systèmes d'Essuyage, Le Mesnil Saint Denis (FR)

(21) Appl. No.: 16/082,728

(22) PCT Filed: Mar. 8, 2017
(86) PCT No.: PCT/EP2017/055452

§ 371 Date: Sep. 6, 2018

(30) Foreign Application Priority Data
Mar. 10, 2016 (FR) 1652015

(51) Int. Cl. B60S 1/56; B60R 11/04; G03B 17/08; B60S 1/54; B60S 1/52; H04N 5/225

(52) U.S. Cl. CPC B60S 1/56; B60R 11/04; G03B 17/08; G03B 17/56; B60S 1/52; H04N 5/2252; B60S 1/54

(57) ABSTRACT

The invention relates to an optical detection system (1) for a motor vehicle, comprising:
a protective housing (3), and
an optical sensor (5) housed in the housing (3),
   characterized in that it comprises firstly a grating (8) positioned on the optical axis (A) of the optical sensor (5) in the field of view thereof and perpendicular to this optical axis (A), and secondly a generator (19) for generating an airflow in the direction of the grating (8).

The present invention relates to an optical detection system for a motor vehicle.

Optical detection system is the name given to any system including optical sensors, such as cameras, laser sensors (commonly called LIDARs) or other sensors based on the emission and/or the detection of light in the spectrum visible or invisible to humans, in particular the infrared.

Nowadays, rear view cameras in particular are fitted on a large number of modern motor vehicles, and they form part in particular of a parking assistance system that makes it possible to park in a space more easily without having to turn around and detect obstacles situated behind the vehicle.

Cameras that are installed inside the passenger compartment against the rear windscreen/pane and that point backward through the rear windscreen of the vehicle are known. These cameras are well protected against external climatic influences and may for example benefit from systems for defrosting and cleaning the rear windscreen, for example a heating wire integrated into the pane of the rear windscreen.

However, the viewing angle is not optimal, in particular for parking assistance, and for this reason it is preferred for the camera to be arranged on the rear bumper or on the rear license plate of the vehicle.

In this case, the camera is therefore highly exposed to projections of dirt that may build up on its optics and thus reduce its effectiveness, or even make it inoperative.

In particular in periods of wet weather, projections of rain and dirt occur that may greatly affect the operability of the optical detection system.

To counter the build-up of dirt on the camera, it is known to arrange a device for cleaning the optics of the camera, generally a sprayer of cleaning liquid, in proximity thereto, in order to remove the polluting elements that build up over time.

Likewise, in cold weather, frost may build up on the optics of the camera, making it inoperative.

Known prior art is for example disclosed by document FR2841488 in the name of the Applicant, in which a sprayer projects for example a pressurized cleaning liquid onto a protective pane of the camera. The sprayer is furthermore assisted by vibration means that make it possible to detach stubborn dirt from the protective pane of the camera, which pane may be heated in order to be protected against the build-up of frost in cold weather.

However, it has been observed that the operation of this viewing system may be optimized. Specifically, following the projection of a cleaning liquid onto the optics of the camera, there may still be drops clinging to the protective pane, thereby impairing and deforming the image taken by the camera. The presence of the drops of cleaning liquid results from the fact that the cleaning liquid does not slide easily over the surface of the optics of the camera. Moreover, the evaporation of the drops on the protective pane leaves smears that are able to be seen on the image taken by the camera.

Given that the cameras that are used are increasingly small, the size of the clinging drops becomes large with respect to the surface of the protective pane and may significantly alter the image captured by the camera.

The present invention proposes to at least partially rectify one or more of the abovementioned drawbacks by presenting an alternative optical detection system that makes it possible to prevent the build-up of dirt on the camera.

To this end, the subject of the invention is an optical detection system for a motor vehicle, comprising:
a protective housing, and
an optical sensor housed in the housing, characterized in that it comprises firstly a grating positioned on the optical axis of the optical sensor in the field of view thereof and perpendicular to this optical axis, and secondly a generator for generating an airflow in the direction of the grating.

By virtue of the airflow passing through the grating, microturbulence is created downstream of the grating that prevents water, dust or more generally dirt from passing through the grating in the direction of the camera and building up on the lens of the camera.

The optical detection system according to the invention may furthermore include one or more of the following features, taken alone or in combination:

According to one aspect, the grating has meshes of parallelepipedal shape, in particular of square shape.

The length of one side of a mesh is for example between 0.5 mm and 2.5 mm, in particular equal to 2 mm.

According to another aspect, the grating is formed of wires having a diameter of less than 0.05 mm, in particular between 0.02 mm and 0.04 mm.

The grating may be formed of wires made of stainless steel or made of plastic, in particular made of composite material.

It may be provided that the grating comprises resistive wires that are able to be heated by the Joule effect and is configured to be connected to an electric power source in order to heat the grating.

According to yet another aspect, the protective housing has a cylindrical shape and the grating has a disk shape that closes one end of the ends of the protective housing.

As a variant or in addition, the protective housing has a cylindrical shape and the grating has a shape that is able to cover the viewing angles of the optical sensor.

It may also be provided for the airflow to surround the optical sensor.

According to yet another aspect, the airflow generator is integrated into the protective housing.

The airflow generator comprises for example an air blower positioned at the rear the protective housing.

As a variant, the airflow generator comprises a compressor situated outside the protective housing.

The optical detection system may furthermore comprise at least one nozzle for projecting a cleaning liquid onto the face of the grating facing the optical sensor.

According to another aspect, the optical detection system comprises a plurality of nozzles for projecting a cleaning liquid that are distributed regularly around the optical sensor and project inside the protective housing.

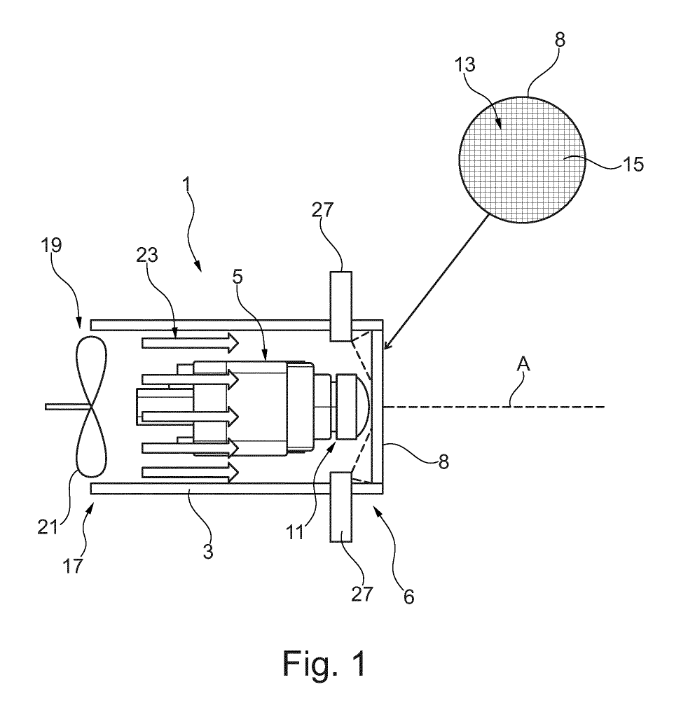

Other advantages and features will emerge from reading the description of the invention and from the single FIG. 1, which shows, in a longitudinal sectional view, a simplified diagram of one embodiment of an optical detection system whilst also showing a detailed view of a grating in a frontal view.

The following embodiments are examples. Although the description refers to one or more embodiments, this does not necessarily mean that each reference relates to the same embodiment, or that the features apply only to just one embodiment. Single features of various embodiments can also be combined or interchanged in order to create other embodiments.

In the description, the terms ‘upstream’ and ‘downstream’ are used with respect to the flow direction of the fluids in the fluid lines. Thus, a first element is positioned upstream of a second element if the fluid passes through the first element first, and then through the second element.

FIG. 1 shows one embodiment of an optical detection system 1 according to the invention for a motor vehicle.

The optical detection system 1 is for example intended to be installed at the rear of a motor vehicle, for example on a bumper or on a license plate (these not being shown). It may also for example be installed on the sides of the vehicle, for example as a substitute for the side mirrors.

The optical detection system 1 comprises a protective housing 3 and an optical sensor 5, in particular for taking images, such as a camera, that is installed in the protective housing 3.

The protective housing 3 is for example of cylindrical shape and comprises a grating 8 at one end 6. In the same FIGURE, the grating 8 is also shown front-on.

The optical sensor 5 comprises, for example enclosed in a casing 9, a CCD (for ‘charge-coupled device’) measurement sensor or a CMOS measurement sensor formed of a matrix array of miniature photodiodes. This measurement sensor is linked for example to a processing unit comprising in particular a microprocessor for processing the data/images that are taken.

The optical sensor 5 additionally comprises optics 11, for example a convex (curved) lens, such as a fish-eye lens, attached to the casing 9 in front of the measurement sensor in a sealtight manner.

As is seen in the FIGURE, the grating 8 is positioned on the optical axis A of the optical sensor 5 in the field of view thereof, and perpendicular to this optical axis A.

The grating 8 has for example meshes 13 of parallelepipedal shape, in particular of square shape. The length of one side of a mesh 13 may be between 0.5 mm and 2.5 mm, in particular equal to 2 mm. The grating 8 is in particular formed of wires 15 having a diameter of less than 0.05 mm, in particular between 0.02 mm and 0.04 mm.

Thus, on account of the proximity of the grating 8 with respect to the optical sensor 5 and of the focal length of the optics 11, which is for example greater than 1 m, this grating 8 does not appear in the images that are taken.

The grating 8 is for example formed of wires 15 made of a material that is able to be exposed to adverse conditions without being altered, in particular made of stainless steel or made of plastic, in particular made of composite material, for example a fiber-reinforced plastic.

According to one variant, the grating 8 comprises resistive wires that are able to be heated by the Joule effect and the grating 8 is configured to be connected to an electric power source in order to heat the grating 8. Thus, if ice has built up on the grating 8, said ice is able to be eliminated by heating the grating 8 by supplying the resistive wires with an electric current. The resistive wires may at least partly form the wires 15 of the grating 8.

In order to effectively close the end 6 of the protective housing 3, the grating 8 has a disk shape.

As a variant, this shape of the grating may be different provided that the grating 8 has a shape that is able to cover the viewing angles of the optical sensor 5.

At that end 17 of the protective housing 3 that is opposite the end 6 that bears the grating 8, the optical detection system 1 comprises a generator 19 for generating an airflow in the direction of the grating 8.

The airflow generator 19 is for example integrated into the protective housing 3 and comprises an air blower 21 positioned at the rear of the protective housing 3.

On account of the position of the generator 19, the airflow indicated by arrows 23 surrounds the optical sensor 5.

According to one variant, not shown, the airflow generator comprises a compressor situated outside the protective housing 5 for delivering a compressed airflow in the direction of the grating 8.

Optionally, the optical detection system 1 furthermore comprises at least one nozzle 27 for projecting a cleaning liquid onto the face of the grating 8 facing the optical sensor 5.

As is seen in the FIGURE, the system may comprise a plurality of nozzles 27 for projecting a cleaning liquid that are distributed regularly around the optical sensor 5 and project inside the protective housing 3.

These projection nozzles 27 are for example linked to a cleaning liquid tank (not shown) by way of a pump. This may be for example the tank and the pump of a cleaning system.

During operation, the airflow generator 19, for example in the form of a blower 21 with rotating blades, drives an airflow from the rear of the protective housing in the direction of the grating 8.

This airflow surrounds the optical sensor 5 and makes it possible, if necessary, to clean the grating 8 from dirt that has built up on the grating 8. This cleaning action may be supplemented by projecting a cleaning liquid by way of the projection nozzles 27.

If ice has built up on the grating 8, said ice is able to be heated in order to melt it.

Then, on account of the constant airflow, microturbulence, which prevents dirt and water from penetrating into the protective housing 3, is created at the grating 8 downstream thereof.

A field of view is thus achieved for the optical sensor 5 that is always clear and clean. By virtue of the airflows, the consumption of a cleaning fluid is limited, and there is no problem with smears left by the cleaning liquid. The optical sensor 5 is also protected independently of the travel speed of the vehicle.

1. An optical detection system for a motor vehicle, comprising:
a protective housing;
an optical sensor housed in the housing;
a grating positioned on the optical axis of the optical sensor in the field of view thereof and perpendicular to the optical axis; and
a generator for generating an airflow in the direction of the grating.

2. The optical detection system as claimed in claim 1, wherein the grating has meshes of square shape.

3. The optical detection system as claimed in claim 2, wherein the length of one side of a mesh is between 0.5 mm and 2.5 mm.

4. The optical detection system as claimed in claim 1, wherein the grating is formed of wires having a diameter of between 0.02 mm and 0.04 mm.

5. The optical detection system as claimed in claim 1, wherein the grating is formed of wires made of composite material.

6. The optical detection system as claimed in claim 1, wherein the grating comprises resistive wires that are heated by the Joule effect and is configured to be connected to an electric power source in order to heat the grating.

7. The optical detection system as claimed in claim 1, wherein the protective housing has a cylindrical shape and the grating has a disk shape that closes one end of the ends of the protective housing.

8. The optical detection system as claimed in claim 1, wherein the protective housing has a cylindrical shape and the grating has a shape that is able to cover the viewing angles of the optical sensor.

9. The optical detection system as claimed in claim 1, wherein the airflow surrounds the optical sensor.

10. The optical detection system as claimed in claim 1, wherein the airflow generator is integrated into the protective housing.

11. The optical detection system as claimed in claim 10, wherein the airflow generator comprises an air blower positioned at the rear the protective housing.

12. The optical detection system as claimed in claim 1, wherein the airflow generator comprises a compressor situated outside the protective housing.

13. The optical detection system as claimed in claim 1, further comprising: at least one nozzle for projecting a cleaning liquid onto the face of the grating facing the optical sensor.

14. The optical detection system as claimed in claim 13, further comprising a plurality of nozzles for projecting a cleaning liquid that are distributed regularly around the optical sensor and project inside the protective housing.
